(19) United States
(12) Patent Application Publication
(10) Pub. No.: US 2024/0189842 A1
(43) Pub. Date: Jun. 13, 2024

(54) Shower Funnel Water-Saving Diverter

(71) Applicant: Thomas D. Fournier, Rolling Hills Estates, CA (US)

(72) Inventor: Thomas D. Fournier, Rolling Hills Estates, CA (US)

(21) Appl. No.: 18/063,686

(22) Filed: Dec. 9, 2022

(51) Int. Cl. B05B 1/18

(52) U.S. Cl. CPC B05B 1/185

(57) ABSTRACT

An apparatus that includes a funnel-shaped tube and a loop of material that is connected to the funnel-shaped tube and allows the funnel-shaped tube to hang from a protrusion. The funnel-shaped tube has a first aperture that accommodates a shower head and a second aperture that is smaller than the first aperture. During shower operation, the funnel-shaped tube causes water from the shower head to form into a narrower stream of water as the water flows from the first aperture to the second aperture.

### BACKGROUND

### Field of the Various Embodiments

The various embodiments relate generally to mechanical engineering and mechanical devices and, more specifically, to a shower funnel water-saving diverter.

### Description of the Related Art

As of Oct. 18, 2022, over 82 percent of the continental United States is facing abnormally dry conditions. This is the highest percentage ever recorded since the U.S. Drought Monitor launched in the year 2000. And almost 35% of the continental United States is experiencing severe to exceptional drought conditions. Allocations of water from the Colorado River to western states are being cut. Water levels behind hydro-electric dams along the Colorado River are so low they are at risk of being unable to generate electricity. Parts of the Mississippi River are so low that commercial river traffic is threatened and supply disruptions are possible. And Climatologists warn that climate change will increase the risk of droughts in the future. Clearly, saving water in any way possible is becoming more important every day.

There are many ways to save water. There are water saving appliances and water conservations systems like cisterns, tankless water heaters and drip irrigation systems. But many of these systems are complex and require significant expertise to install them. Furthermore, people living in rental units may not have the right to install these devices and a large portion of the population simply cannot afford them.

One water saving opportunity for every household is saving the cold water that comes out of the shower head while the user waits for the water to heat up. The amount of water that goes down the drain while waiting for it to heat up depends on the distance between the shower and the water heater. In some cases, when a shower is on the opposite side of the house from the water heater, three or more gallons of water can be wasted while waiting for it to reach the desired temperature. In cases where there is a tub/shower combination, users can easily place a bucket under the tub faucet to capture the water while it is heating. However, when there is only a shower unit, placing a bucket under the shower head is not as effective. Because the spray pattern of most shower heads is wider than a bucket or watering pot, up to 50% of the water is not captured (depending on the shower head). If most or all of this potable water could be successfully captured, then that water could be used to fill toilet tanks, water plants, fill water bowls for pets and fulfil a variety of other water needs and reducing our overall water consumption.

Several different types of devices have been previously designed to capture this wasted water. In one example, an upside-down umbrella is deployed while shower water is warming up. The umbrella captures shower water and directs the water into a container that holds the water. One drawback of this design is the complexity of the apparatus. In some implementations, the umbrella itself includes approximately twenty distinct parts, including spring loaded devices and delicate rods to hold the umbrella shield. Additionally, the umbrella device only works with a specially-designed water collection canister that also serves as a storage space for the collapsed umbrella. The complex design package makes the product expensive to produce, difficult to use, and susceptible to mechanical failures.

In another example, a collection device is attached on the wall of a shower and, through a series of PVC pipes, directs water to a collection canister. One drawback of this design is that to be effective, the opening aperture needs to be large, which makes the device obtrusive in a confined shower space. In addition, the device amounts to a permanent structure that is unsightly and difficult to clean around. Lastly, with this design, the water collection canister typically resides outside of the shower. Consequently, installation requires cutting through glass to allow pipe to pass through on an enclosed shower or having a pipe extending out the opening of the shower. This type of design is unsightly, obtrusive, and difficult to install and maintain.

In yet another example, a molded reservoir serves as the base off the shower and is designed to capture both clean and gray water. The molded base has individual reservoirs that can be removed, and the water used for non-potable purposes. One drawback with this design is that the design is complex, expensive to install, and can be prone to sanitary concerns. In particular, installation requires rebuilding and re-piping the entire shower to incorporate the molded reservoir. In addition, the gray water collected may be unsanitary and produce unpleasant odors, unless the reservoirs are emptied after each use.

As the foregoing illustrates, what is needed in the art are more effective techniques for collecting shower water during shower use.

### SUMMARY

The disclosed embodiments, among other things, address the complexity and installation deficiencies found in prior art designs. In various embodiments, an apparatus includes a funnel-shaped tube and a loop of material that is connected to the funnel-shaped tube and allows the funnel-shaped tube to hang from a protrusion. The funnel-shaped tube has a first aperture that accommodates a shower head and a second aperture that is smaller than the first aperture. During shower operation, the funnel-shaped tube causes water from the shower head to form into a narrower stream of water as the water flows from the first aperture to the second aperture.

The disclosed embodiments advantageously funnel water from the shower head into a single stream such that the water can be easily collected in a bucket or other portable collection canister, such as a bucket or a can, for future use. The disclosed embodiments also advantageously reduce water waste that occurs while users are waiting for the shower water to heat. In addition, the disclosed embodiments are portable and unobtrusive in a shower environment, and no physical changes to the shower are needed for adoption.

### BRIEF DESCRIPTION OF THE DRAWINGS

So that the manner in which the recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a side view of a funnel-shaped tube unattached to a shower head. according to various embodiments.

FIG. 2 is a detailed cutout illustration of the funnel-shaped tube of FIG. 1, attached to the shower head and showing the operation of the device, according to various embodiments.

FIG. 3 is a holistic view of the funnel-shaped tube of FIG. 1 operating within a shower, according to various embodiments.

FIG. 4 is a view of the funnel-shaped tube of FIG. 1 while not in use hanging from a shower faucet handle by the elastic hook ring, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

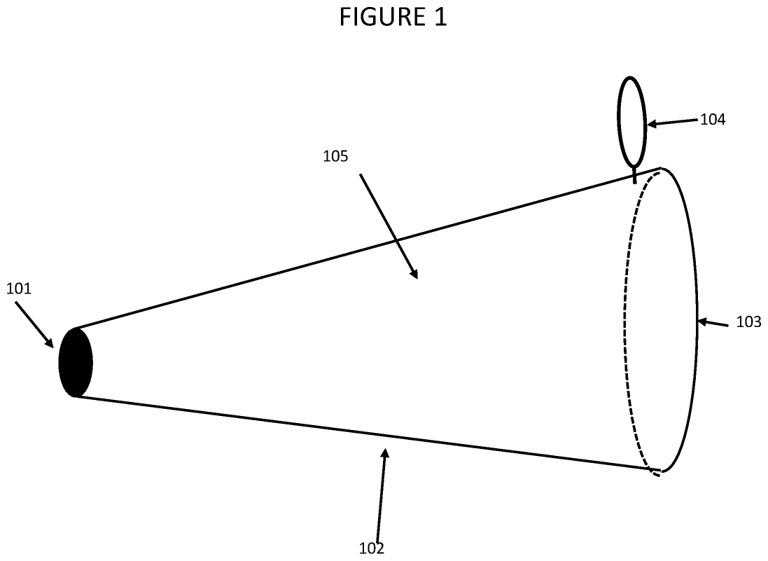

FIG. 1 is a more detailed illustration of the funnel-shaped tube, according to various embodiments. As shown, FIG. 1 is a side view of a funnel-shaped tube unattached to any shower head. FIG. 1 identifies the dimensions and components of the funnel-shaped tube. Item 101 is the smaller aperture of the shower funnel-tube which allows the narrow stream of water to flow downwards out of the funnel-shaped tube into a collection apparatus. This aperture is circular in shape and can be roughly 1.5 inches in diameter but also can vary. Item 102 is the wall of the funnel-shaped tube. This section of the funnel-shaped tube is where water entering through the wider aperture (Item 103) of the funnel-shaped tube is consolidated into a narrow stream of water that exits through the smaller aperture (Item 101). The length of funnel-shaped tube wall identified as Item 102 can be about 11 inches but can vary based on needs. Item 103 is the wider aperture of the funnel-shaped tube which, when in use, attaches to the shower head. The water from the shower head enters through Item 103 and flows down the funnel-shaped tube walls (Item 102) and exits through the smaller aperture (Item 101) as a narrow stream of water that is directed into a collection apparatus. The size of this aperture may be variable in order to accommodate various sizes and shapes of shower heads. The funnel-shaped tube is made of a waterproof elastic material such as silicone, rubber, or some composite material. This material allows Item 103 to be stretched over the shower head and be snug enough to prevent the funnel-shaped tube from becoming disconnected from the shower head when the water is turned on. Item 104 is a ring-shaped hook that is made of elastic, waterproof material that is attached to the funnel-shaped tube near large aperture (Item 103). This hook is used to hang the funnel-shaped tube from a hook in the shower or from the shower faucet handle once the user enters the shower and removes the funnel-shaped tube from the shower head. This hook allows the user to hang the funnel-shaped tube so it can drip dry and prevents the user from having to leave the funnel-shaped tube on the floor of the shower where is could be in the way. Item 105 is the material from which the funnel-shaped tube is made. It is made of a waterproof elastic material such as silicone, rubber, or some composite material. The material can be of different colors and textures.

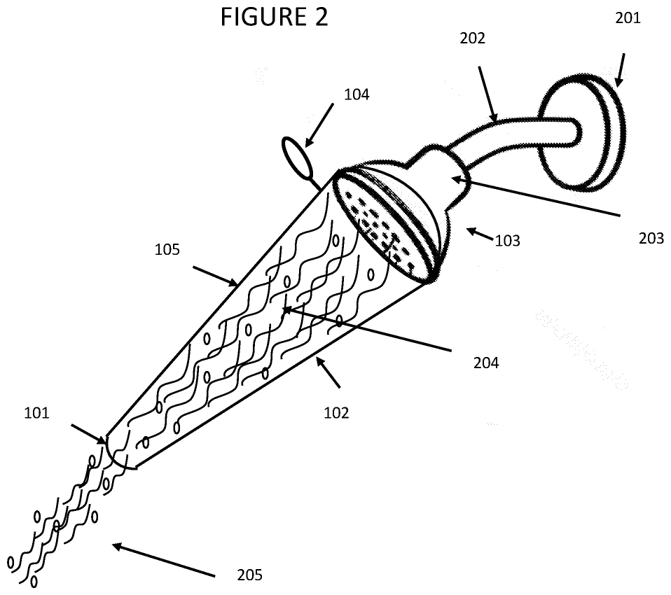

FIG. 2 is a more detailed illustration of the funnel-shaped tube of FIG. 1, according to various embodiments. As shown, FIG. 2 is a cutout view of the funnel-shaped tube when attached to a shower head and directing the water into a narrow stream. Item 201 is the decorative flange the attaches to the wall of the shower and hides the space where the shower water pipe enters the wall. Item 202 is the water pipe that extends from the wall and allows water to flow from the plumbing in the wall of the shower towards the shower head. Item 203 is the shower head to which the funnel-shaped tube attaches. Shower heads come in different shapes and sizes which requires the funnel-shaped tube to be produced in various sizes. Item 204 is the wide flow of water that the shower head produces that is being contained and consolidated by the walls of the funnel-shaped tube (Item 102). The water flows downwards towards the smaller aperture of the funnel-shaped tube (Item 101). Item 205 is the narrow stream of water that the funnel-shaped tube produces that allows the water to flow into the collection apparatus.

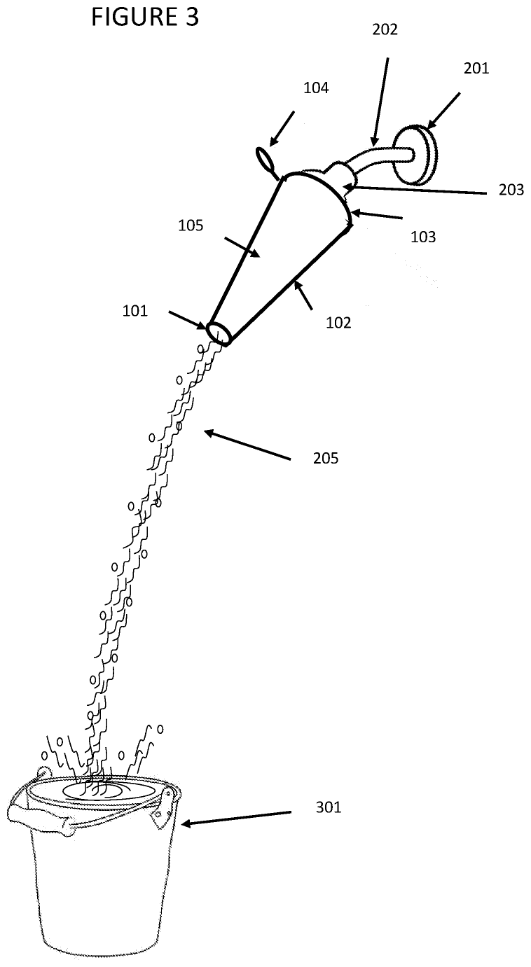

FIG. 3 is a holistic view of the shower with the funnel-shaped tube of FIG. 1, attached and working according to various embodiments. As shown, FIG. 3 the larger aperture of the funnel-shaped tube (Item 103) is attached to the shower head (Item 203). The water is contained by the walls of the funnel-shaped tube (Item 102) and exits out the smaller aperture (Item 101) as a narrower stream of water (Item 205). This narrower stream of water is collected by in the collection apparatus. In FIG. 3, Item 301 is the collection apparatus to captures the water. In this case, Item 301 it is a bucket. However, the choice of a collection apparatus is determined by the user.

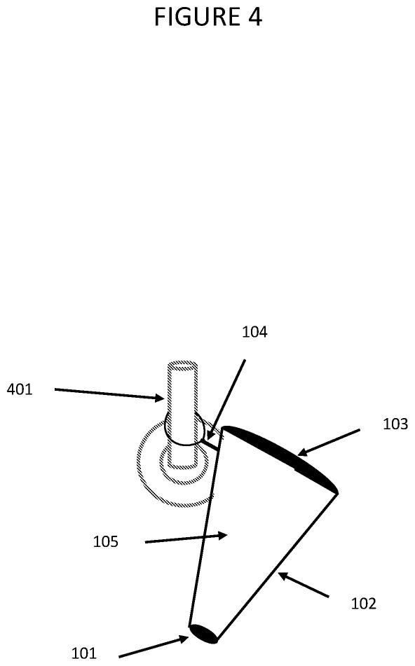

FIG. 4 is a view of the shower with the funnel-shaped tube of FIG. 1 while not in use within the shower, according to various embodiments. As shown, FIG. 4, Item 401 is the faucet handle is the shower that controls the flow of water. These handles come in a variety of styles, sizes, and shapes. Therefore, the shower handle shown is for illustrative purposes only. As shown, the funnel-shaped tube is hung over the faucet handle (Item 401) by the ring-shaped hook (Item 104) that is made of elastic, waterproof material. In this illustration, the hook is used to hang the funnel-shaped tube from shower faucet handle. In other instances, the user might have a hook in the shower from which the funnel-shaped device can be hung. In all cases, the function is to allow the user to hang the funnel-shaped tube from any protrusion chosen so it will drip dry and prevents the user from having to leave the funnel-shaped tube on the floor of the shower where is could be in the way.

What is claimed is:

1. An apparatus, comprising:
a funnel-shaped tube having a first aperture that accommodates a shower head and a second aperture that is smaller than the first aperture, wherein the funnel-shaped tube, during shower operation, causes water from the shower head to form into a narrower stream of water as the water flows from the first aperture to the second aperture; and
a loop of material that is connected to the funnel-shaped tube proximate to the first aperture and allows the funnel-shaped tube to hang from a protrusion.

2. The apparatus of claim 1, wherein the funnel-shaped tube is comprised of rubber, silicone, or a flexible or elastic composite material.

3. The apparatus of claim 1, wherein the funnel-shaped tube is configured to direct the narrower stream of water into a collection apparatus.

4. The apparatus of claim 3, wherein the collection apparatus comprises a bucket or a can.

5. The apparatus of claim 1, wherein at least a portion of the funnel-shaped tube proximate to the first aperture comprises an elastic material allows the funnel-shaped tube to be fastened to the shower head.

6. The apparatus of claim 1, wherein the protrusion comprises a faucet handle, a hook, or a peg.
